(19) United States
(12) Patent Application Publication
(10) Pub. No.: US 2006/0174275 A1
(43) Pub. Date: Aug. 3, 2006

(54) Generation of television recommendations via non-categorical information

(75) Inventor: Srinivas Gutta, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, Eindhoven (NL)

(21) Appl. No.: 10/548,705

(22) PCT Filed: Mar. 2, 2004
(86) PCT No.: PCT/IB04/00683

§ 371 Date: Sep. 8, 2005

Related U.S. Application Data
(60) Provisional application No. 60/453,756, filed on Mar. 11, 2003.

(51) Int. Cl. H04N 5/445; G06F 13/00; H04N 7/025; G06F 3/00; H04N 7/10

(52) U.S. Cl. 725/46; 725/34; 725/35

(57) ABSTRACT

A method for generating recommendations, the method including: entering non-categorical information as feedback for generating a recommendation; generating preference information corresponding to the non-categorical information; and generating the recommendation based at least in part on the generated preference information. Preferably, the method further includes prompting the user for feedback on at least one preference for generating the recommendation prior to the entering.

The present invention relates generally to recommenders, and more particularly, to a recommender that generates recommendations via non-categorical information.

Explicit based TV recommender systems gather users' preferences via an explicit interface. The user is expected to select from among a pre-defined set of preference categories (referred to herein as simply “preferences”), such as station call sign, time of day, day of week, titles, genres like action, comedy-action, suspense-action, comedy, comedy-drama, drama, sports, show ratings (sex, violence, etc.), and language description. The Electronic Program Guide (EPG) provided by Tribune for example has a total of 186 fields, some of which are repeated. As an example there are multiple fields for the shows description, having 10, 20, 40, 80, and 160 characters.

In such an explicit type of TV recommender, a user interface is provided. Beside each button corresponding to the preferences, there is typically a slider provided through which the user is expected to provide information on a 5 point rating system. For example, the user loves the show, likes the show, is neutral about the show, does not like the show, and hates the show. An example of one such recommender is disclosed in co-pending U.S. patent application Ser. No. 09/666,401, filed Sep. 20, 2000 and entitled “Method and Apparatus for Generating Recommendation scores using Implicit and Explicit Viewing Preferences” the entire contents of which is incorporated herein by its reference.

The accuracy of an explicit recommender depends on how well the user believes the preferences capture his/her viewing preferences. In other words, the performance of the TV recommender is very much dependent on the type of preference information provided by the user. However, such an interface is unrealistic as most users find it hard to tell the recommender what their viewing preferences are just by selecting a few categories. Most often, when someone is asked what he or she likes to watch, they often respond with something specific, such as “I like to watch shows like Seinfeld”. This is because it is much easier for some of us to describe our viewing preferences via specific shows/clips rather than relying only on textual information. Thus, most users remember what shows they like based on certain aspects of the show or based on their perception of similarity to other shows.

In spite of this, current explicit based TV recommendation systems force users to provide preference information via a specific set of pre-defined categories.

Therefore it is an object of the present invention to provide a recommender system for generating recommendations that overcome the disadvantages associated with prior art recommender systems.

Explicit based TV recommender systems of the prior art gather users' preferences via an explicit interface. Such recommenders recommend programs of interest to the user depending upon what categories the user has selected. However, such an interface is often unrealistic, since some users are better able to describe their viewing preferences via specific show examples. Towards that end, the apparatus and methods of the present invention uses non-categorical information to recommend shows that match users viewing preferences.

Accordingly, a method for generating recommendations is provided. The method comprising: entering non-categorical information as feedback for generating a recommendation; generating preference information corresponding to the non-categorical information; and generating the recommendation based at least in part on the generated preference information.

Preferably, the method further comprises prompting the user for feedback on at least one preference for generating the recommendation prior to the entering. Preferably, prior to generating the recommendation, the method further comprises highlighting the generated preference information on the user interface. In which base, the method preferably further comprises allowing the user to modify and/or accept the highlighted preference information for generation of the recommendation. Preferably, the method also further comprises allowing the user to assign weights to the highlighted preference information.

In a first variation, the generating of the recommendation generates a recommendation for television programs and in such an instance the non-categorical information comprises selecting a title of a television program representative of the preferences of the user from a plurality of titles. Where the entering of the non-categorical information is the selection of a title of a television program, the generating of the preference information preferably comprises: accessing a database having the plurality of titles and corresponding preference information for each of the plurality of titles; searching the database for the selected title; and retrieving the preference information corresponding to the selected title.

In a second variation, the generating of the recommendation generates a recommendation for television programs and in such an instance the non-categorical information comprises selecting a portion of a television program representative of the preferences of the user from a plurality of portions of television programs. Where the entering of non-categorical information is the selection of a portion of a television program, the generating of the preference information preferably comprises: accessing a database having the plurality of portions of television programs and corresponding preference information for each of the plurality of portions of television programs; searching the database for the selected portion of television program; and retrieving the preference information corresponding to the selected portion of the television program.

In a third variation, the generating of the recommendation preferably generates a recommendation for television programs and in such an instance the non-categorical information preferably comprises providing a portion of a television program representative of the preferences of the user. Where the entering of non-categorical information comprises providing a portion of a television program, the generating of the preference information preferably comprises: determining a similarity between the provided portion of television program and at least one portion of a television program from a plurality of portions of television programs stored in a database; and retrieving preference information corresponding to the at least one similar portion of the television program. The determining preferably comprises applying at least one of a similarity and distance metrics to the provided portion of television program.

The method preferably further comprises assigning weights to the generated preference information prior to generation of the recommendation.

Also provided is an apparatus for generating recommendations. The apparatus comprising: means for entering non-categorical information as feedback for generating a recommendation; means for generating preference information corresponding to the non-categorical information; and a recommender for generating the recommendation based at least in part on the generated preference information.

In a first variation, the recommender generates a recommendation for television programs and the means for entering non-categorical information comprises means for selecting a title of a television program representative of the preferences of the user from a plurality of titles. In such an instance, the means for generating the preference information preferably comprises: a database having the plurality of titles and corresponding preference information for each of the plurality of titles; means for searching the database for the selected title; and means for retrieving the preference information corresponding to the selected title.

In a second variation, the recommender generates a recommendation for television programs and the means for entering non-categorical information comprises means for selecting a portion of a television program representative of the preferences of the user from a plurality of portions of television programs. In such an instance, the means for generating the preference information preferably comprises: a database having the plurality of portions of television programs and corresponding preference information for each of the plurality of portions of television programs; means for searching the database for the selected portion of television program; and means for retrieving the preference information corresponding to the selected portion of the television program.

In a third variation, the recommender generates a recommendation for television programs and the means for entering non-categorical information comprises means for providing a portion of a television program representative of the preferences of the user. In such an instance, the means for generating the preference information comprises: a database having a plurality of portions of television programs and corresponding preference information for each of the plurality of portions of television programs; means for determining a similarity between the provided portion of television program and at least one of the plurality of portions of television programs stored in the database; and means for retrieving preference information corresponding to the at least one similar portion of the television program.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

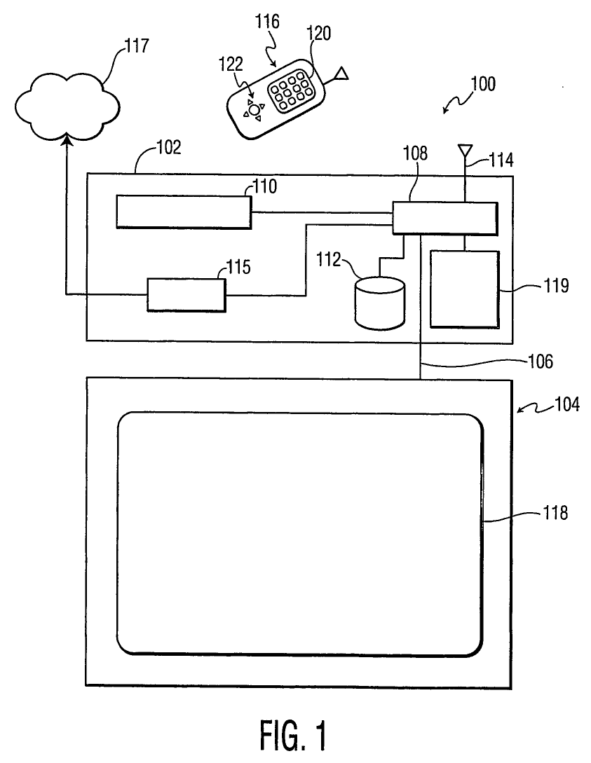

FIG. 1 illustrates a schematic illustration of a preferred implementation of an apparatus for carrying out the methods of the present invention.

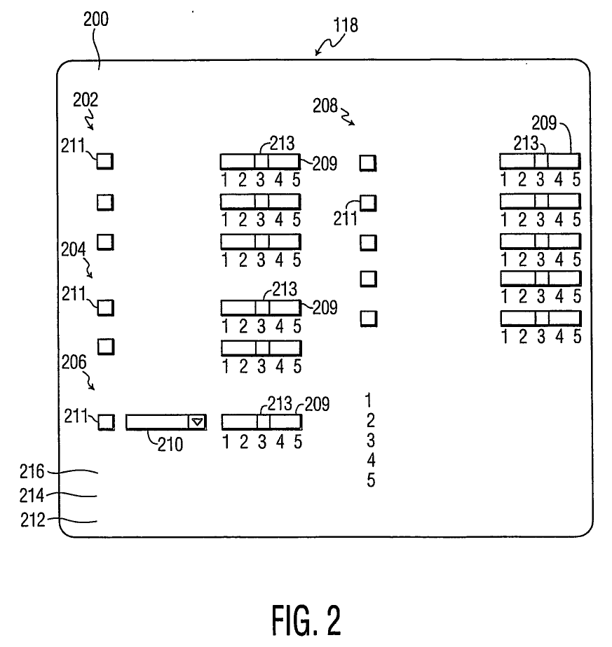

FIG. 2 illustrates a preferred implementation of a user interface for entering feedback useful for generation of a recommendation.

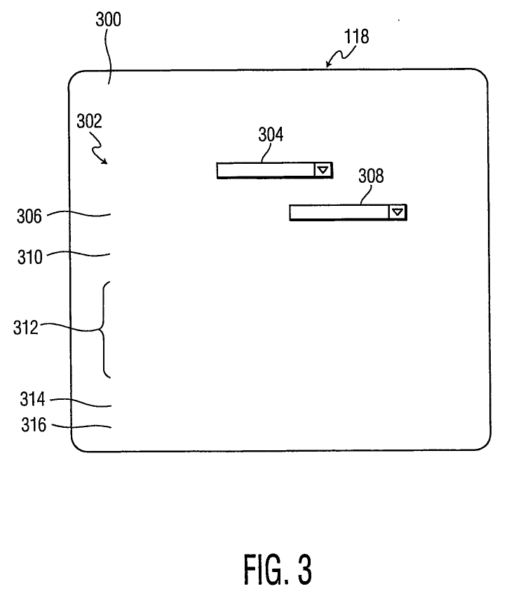

FIG. 3 illustrates a preferred implementation of a user interface for choosing among several non-categorical information choices.

Although this invention is applicable to numerous and various types of content for which a recommendation is made, it has been found particularly useful in the environment of video content and more particularly in the environment of television programming. Therefore, without limiting the applicability of the invention to generating a recommendation for video content and television programming, the invention will be described in such environment.

Referring now to FIG. 1, there is shown a preferred implementation of an apparatus for generating recommendations, the apparatus being generally referred to by reference numeral 100. The apparatus 100 is preferably configured in a set-top box 102 operatively connected to a display 104, such as a television, by way of a video output 106. However, those skilled in the art will appreciate that the apparatus 100 can be integrally formed in the display 104. The set-top box 102 includes a central processor 108 operatively connected to a recommender 110, a storage device 112, a receiver 114, a communication means 115, such as a modem, and a data input means 119.

The recommender 110, alternatively referred to as a recommender engine, generates recommendations for video content, such as television program, or other content in response to user feedback and/or viewing habits of a user. Such recommenders 110 are well known in the art, such as that disclosed in co-pending U.S. application Ser. No. 09/666,401 filed on Sep. 20, 2000 and entitled “Method and Apparatus for Generating Recommendation Scores Using Implicit and Explicit Viewing Preferences”, the contents of which is incorporated herein by its reference. The storage device 112, such as a hard drive, stores video content for later viewing by the user and program instructions for operation of the apparatus. Although the recommender 110 is shown schematically as a separate device, it may also be contained in a set of program instructions on the storage device 112. Furthermore, although the storage device 112 is shown as a single device, it may comprise two or more storage devices, each of which is operatively connected to the processor 108. The modem 115, under the control of the processor 108 is operatively connected to a network 117 for receiving data from the network 117 or sending data to the network 117. The data input means 119 can be a floppy disk drive, CD drive, DVD drive, or other means for reading a portable storage medium. The data input means 119 may also be a connector, such as a USB port, for connecting to another device, such as a computer, for uploading data to the apparatus 100.

The receiver 114 receives wireless signals from a remote control 116 indicating control signals for remote operation of the apparatus and for entering information into the apparatus through a user interface reproduced on a screen 118 of the display 104. The processor 108 receives the wireless signals from the remote control 116 and has means for de-multiplexing the same from other signals or noise and for transforming the same, if necessary, to be usable with the apparatus 100. The processor 108 further controls the recommender 110 and storage device 112, generates the user interface, and outputs the same to the display 104 for viewing on the screen 118. As is well known in the art, a user enters and traverses the user interface with the remote control 118 by pressing simple buttons 120 and/or manipulating a joystick button 122 on the remote control.

Referring now also to FIGS. 2 and 3, a preferred implementation of a method for generating recommendations will be discussed. As discussed above, some types of recommenders use feedback from a user to help in generating a recommendation for video or other content. The recommendation can be based partially or wholly on the feedback. The methods of the present invention are directed to such recommenders. Generally, a user interface, referred to in FIG. 2 by reference numeral 200, is generated and viewed on the screen 118 of the display 104 under control of the processor 108. The user interface prompts a user for feedback on at least one preference for generating a recommendation. Examples of preferences include a preferred time slot 202, such as prime time, late night, and weekend; a preferred language 204, such as English or Spanish; a preferred actor 206; and a preferred genre 208, such as action, comedy, drama, documentary, and romance. The user interface 200 may also ask the user to weigh each selected preference, such as by providing a slider 209 having a five-point weighing scale as discussed above.

The preferences 202-208 can be selected by traversing the list with the joystick button 122 on the remote control 116 and pressing an enter button when a button 211 corresponding to an appropriate preference 202-208 is highlighted or by traversing to a drop-down list 210 corresponding to one or more of the preferences 202-208 and selecting an entry in the drop-down list 210. Once selected, the preferences preferably remain highlighted to provide the user with a “map” of his or her preferences. The sliders 209 are similarly selected and once selected, a corresponding weight to be assigned to the corresponding preference can be entered by using the joystick button 122 to move a slider button 213 left or right. Alternatively, the weight can be entered by entering a numerical value between 1 and 5. Of course, the preferences 202-208 are given by way of example only, not intended to be an exhaustive listing thereof, and are further not intended to limit the scope or spirit of the invention to those described. For example, other preferences include station call signal, ratings, and day of week. An “Enter Non-Categorical Preferences” 214 choice is provided for entering non-categorical information, as discussed below. Furthermore, an “Enter Preferences” 216 choice is provided on user interface 200 to enter the highlighted preferences for use in generation of a recommendation. Lastly, an “Exit” 212 choice is also provided on the user interface 200 to exit the feedback process and resume another operation of the apparatus 100 or display 104.

In general, the methods of the present invention ease the burden on the part of the user to provide preference information. The methods preferably augment existing explicit recommender user interfaces by providing the ability to accept as viewing preferences non-categorical information. The non-categorical information can be based on titles of shows, Video clips/trailers of a show, and/or video clips pertaining to specific parts of the show. The user interface 200 is augmented as discussed above by allowing the user to enter non-categorical information such as giving examples of other shows that the user previously liked. As discussed immediately below, this could be done in a number of ways.

Firstly, the user can provide for specific titles of shows. These titles are then searched against a TV program database to retrieve the relevant show information. A show program record contains around 186 features as mentioned above. Based on the show features, the system preferably automatically highlights the appropriate buttons 211 when it returns to user interface 200. The user then accepts or modifies the highlighted information. Where weights could be given to each one of the fields that constitute the show, the user would then enter the weights for each of the highlighted categories, such as by moving the corresponding slider button 213 as discussed above. The remaining process of generating recommendations would be the same as is currently being done in the art. Namely, the selected preferences and weights, if any, are entered by selecting the “Enter Preferences” 216 choice on user interface 200 and are used by the recommender 110 to generate recommendations for other programs.

The user could also select a clip/trailer from a program database that satisfies his interests. The corresponding show information is retrieved and the remaining process would be the same where the user selects a title as described above.

The user could also be provided the flexibility to upload a clip/trailer or specific parts of a show into the apparatus 100. In the case of video clips, the apparatus ascertains its similarity with other shows having the same image content information by employing similarity and/or distance metrics. Common examples of these distance metrics include Eucliedian and Mahanabolis and other metrics such as color histogram analysis to find other clips/trailers as discussed above for which show information is available and follow the same process as described above. Such use of similarity metrics is well known in the art. The use of histogram analysis is also well known in the art, such as that disclosed in co-pending U.S. patent application Ser. No. 09/866,394, Filed May 25, 2001 and entitled “Compact Visual Summaries using Super Histograms and in European Patent EP1038269A1, issued Sep. 27, 2000, entitled “A Histogram Method for Characterizing Video Content, the contents of both of which are incorporated herein in their entirety by their reference. The comparison can then be done via features or between key frames. Other clips that are found to be similar could be recommended to the user or used to highlight corresponding preferences 202-208 on user interface 200.

Preferably, the user enters the non-categorical preference as a manual operation by selection of the “Enter Non-Categorical Preferences” 214 choice on user interface 200. Such a selection preferably switches the user interface to a user interface shown in FIG. 3, referred to generally by reference numeral 300. Alternatively, user interface 300 can pop-up as a window without replacing user interface 200. Furthermore, the entering of non-categorical preferences can be used automatically for selecting preferences as a default operation or may be the only preference selection means offered by the apparatus 100.

User interface 300 contains a listing of non-categorical information choices, such as those discussed above. The first choice is the entering of a title 302. The title can be entered alphanumerically by depressing appropriate buttons on the remote control (or other data entry device, such as a keyboard) or a drop-down list 304 can be provided, which the user can traverse with the joystick button 122 on the remote control 116. As discussed above, after a title is selected, such as “Seinfeld,” a database, preferably stored in the storage device 112 of the apparatus 100 is searched and corresponding preference information is highlighted on the preference listing in user interface 200. For the title “Seinfeld,” preferences such as “primetime,” “English,” “Jerry Seinfeld,” and “comedy” will be highlighted in preferences 202-208, respectively. The user then modifies the highlighted preferences or accepts them on user interface 200. The user can also select weights for the preferences, such as by moving the slider button 213 corresponding to each preference to an appropriate position. Alternatively, the apparatus can contain the communication means 115 for accessing a remote database having the titles and corresponding preference information or the database on the storage device 112 can be periodically updated through the communication means 115.

As also discussed above, the “choose clip/trailer” 306 choice can be selected at user interface 300. Preferably, the user can select a clip/trailer from a drop-down listing 308 of available clips/trailers or clips/trailers representative of a certain genre. Alternatively, the user can enter a title alphanumerically or via a drop-down menu to choose a corresponding clip/trailer from the title. If satisfied with his/her choice, the user can then select the preferred clip/trailer by traversing to the “Input Non-Categorical Preferences” 314 choice. The corresponding clip/trailer is retrieved from the database (or alternatively from a remote location via a communication means 115) and the remaining process would be the same where the user selects a title as described above. As discussed above with regard to the title, the database can be periodically updated through the communication means 115. A “Back” 316 choice is also provided on user interface 300 to return to user interface 200. If user interface 300 is a window, the “Back” 316 choice is replaced with a “Close Window” choice.

Another choice of non-categorical information, as discussed above, is the “Upload Clip/Trailer” 310 choice as well as entering a location 312 where the clip/trailer is uploaded. Preferably, the user provides a portion of a TV show to the apparatus 100 through the data input means 119, such as on a DVD or other storage medium, via the communication means 115, or through a connector, such as a USB port. After choosing the “Input Non-Categorical Preferences” 314 choice, the apparatus uploads the data from the indicated source, analyzes the portion of TV show, either on the fly or after it is stored on the storage device 112, and ascertains its similarity with other shows having the same image content information by employing distance or similarity metrics as discussed above. The corresponding preference information for the similar shows is retrieved from the database and the remaining process is the same where the user selects a title as described above.

Those skilled in the art will appreciate that the particular non-categorical choices discussed above are given by way of example only and not to limit the scope or spirit of the present invention. Furthermore, although the preferred methods have been discussed where the non-categorical information individually contribute to the generation of preferences, those skilled in the art will appreciate that they may also contribute in combination. For example, the user may select both the “Enter Title” 302 choice and the “Choose Clip/Trailer” 306 choice before selecting the “Input Non-Categorical Preferences” 314 choice. The recommender 110 would use both to generate the preferences according to predetermined criteria, such as assigning a weighting factor to each different type of non-categorical information.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device, such as storage device 112.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for generating recommendations, the method comprising:
entering non-categorical information as feedback for generating a recommendation;
generating preference information corresponding to the non-categorical information; and
generating the recommendation based at least in part on the generated preference information.

2. The method of claim 1, further comprising prompting the user for feedback on at least one preference for generating the recommendation prior to the entering.

3. The method of claim 1, wherein the generating of the recommendation generates a recommendation for television programs and wherein the non-categorical information comprises selecting a title of a television program representative of the preferences of the user from a plurality of titles.

4. The method of claim 3, wherein the generating of the preference information comprises:
accessing a database having the plurality of titles and corresponding preference information for each of the plurality of titles;
searching the database for the selected title; and
retrieving the preference information corresponding to the selected title.

5. The method of claim 1, wherein the generating of the recommendation generates a recommendation for television programs and wherein the non-categorical information comprises selecting a portion of a television program representative of the preferences of the user from a plurality of portions of television programs.

6. The method of claim 5, wherein the generating of the preference information comprises:
accessing a database having the plurality of portions of television programs and corresponding preference information for each of the plurality of portions of television programs;
searching the database for the selected portion of television program; and
retrieving the preference information corresponding to the selected portion of the television program.

7. The method of claim 1, wherein the generating of the recommendation generates a recommendation for television programs and wherein the non-categorical information comprises providing a portion of a television program representative of the preferences of the user.

8. The method of claim 7, wherein the generating of the preference information comprises:
determining a similarity between the provided portion of television program and at least one portion of a television program from a plurality of portions of television programs stored in a database; and
retrieving preference information corresponding to the at least one similar portion of the television program.

9. The method of claim 8, wherein the determining comprises applying at least one of a similarity and distance metrics to the provided portion of television program.

10. The method of claim 2, wherein, prior to generating the recommendation, the method further comprises highlighting the generated preference information on the user interface.

11. The method of claim 10, further comprising allowing the user to modify and/or accept the highlighted preference information for generation of the recommendation.

12. The method of claim 10, further comprising allowing the user to assign weights to the highlighted preference information.

13. The method of claim 1, further comprising assigning weights to the generated preference information prior to generation of the recommendation.

14. An apparatus for generating recommendations, the apparatus comprising:
means for entering non-categorical information as feedback for generating a recommendation;
means for generating preference information corresponding to the non-categorical information; and
a recommender for generating the recommendation based at least in part on the generated preference information.

15. The apparatus of claim 14, wherein the recommender generates a recommendation for television programs and the means for entering non-categorical information comprises means for selecting a title of a television program representative of the preferences of the user from a plurality of titles.

16. The apparatus of claim 15, wherein the means for generating the preference information comprises:
a database having the plurality of titles and corresponding preference information for each of the plurality of titles;
means for searching the database for the selected title; and
means for retrieving the preference information corresponding to the selected title.

17. The method of claim 14, wherein the recommender generates a recommendation for television programs and wherein the means for entering non-categorical information comprises means for selecting a portion of a television program representative of the preferences of the user from a plurality of portions of television programs.

18. The apparatus of claim 17, wherein the means for generating the preference information comprises:
a database having the plurality of portions of television programs and corresponding preference information for each of the plurality of portions of television programs;
means for searching the database for the selected portion of television program; and
means for retrieving the preference information corresponding to the selected portion of the television program.

19. The apparatus of claim 14, wherein the recommender generates a recommendation for television programs and wherein the means for entering non-categorical information comprises means for providing a portion of a television program representative of the preferences of the user.

20. The apparatus of claim 19, wherein the means for generating the preference information comprises:
a database having a plurality of portions of television programs and corresponding preference information for each of the plurality of portions of television programs;
means for determining a similarity between the provided portion of television program and at least one of the plurality of portions of television programs stored in the database; and
means for retrieving preference information corresponding to the at least one similar portion of the television program.

21. A computer program product embodied in a computer-readable medium for generating recommendations, the computer program product comprising:
computer readable program code means for entering non-categorical information as feedback for generating a recommendation;
computer readable program code means for generating preference information corresponding to the non-categorical information; and
computer readable program code means for generating the recommendation based at least in part on the generated preference information.

22. A program storage device readable by machine, tangibly embodying a program of instructions executable by the machine to perform method steps for generating recommendations, the method comprising:
entering non-categorical information as feedback for generating a recommendation;
generating preference information corresponding to the non-categorical information; and
generating the recommendation based at least in part on the generated preference information.
